(19) United States
(12) Patent Application Publication
(10) Pub. No.: US 2018/0092138 A1
(43) Pub. Date: Mar. 29, 2018

(54) WIRELESS CONNECTION THROUGH REMOTE WI-FI PROTECTED SETUP

(71) Applicant: Intel Corporation, Santa Clara, CA (US)

(72) Inventors: Shaw Kee TANG, Bayan Lepas (MY); Kamarul Zaman ABDUL RASHID, Bayan Lepas (MY); Usman SARWAR, Penang (MY)

(21) Appl. No.: 15/279,522

(22) Filed: Sep. 29, 2016

(51) Int. Cl. H04W 76/02; H04W 12/08; H04W 76/06

(52) U.S. Cl. CPC H04W 76/021; H04W 76/068; H04W 12/08

(57) ABSTRACT

Although Wi-Fi Protected Setup (“WPS”) enables simple establishment of a Wi-Fi connection between an Access Point (“AP”) and a Mobile Station (“MS”), there are difficulties associated with using it on a larger scale, such as the AP being physically inaccessible to the intended user. A method and apparatus for establishing a remote Wi-Fi connection with WPS, wherein a AP is connected to one or more Wi-Fi Connection Request Verifiers (“WCRV”), which allow for connection between a MS and the AP. The WCRVs comprise a display for an access code and a WPS button. To establish a connection, users input into their MSs an access code from the display of the WCRV. As an additional safety measure, users must also press a WPS button on the WCRV. Upon completion of these steps, the AP may establish a Wi-Fi connection and transmit encryption information for same.

### TECHNICAL FIELD

Embodiments described herein generally relate to the use of Wi-Fi Protected Setup Activation to establish a convenient link between a mobile station and a Network Access Point.

### BACKGROUND

Wi-Fi Protected Setup (“WPS”) enables a simplified establishment of a Wi-Fi connection between an Access Point (“AP”) and a Mobile Station (“MS”). WPS connections are generally established via either a physical push button on the AP (“WPS-Button”), the touching of the MS to the AP to activate Near Field Communication circuitry (“WPS-NFC”), or by keying in a static PIN (“WPS-PIN”).

Although WPS may simplify the establishment of a Wi-Fi connection, there are difficulties associated with using it on a larger scale. For example, both the WPS-Button and WPS-NFC methods require close physical proximity to the AP that may not be possible in a commercial application, where it may be desirable to locate the AP outside of customer or end user access.

In commercial environments where Wi-Fi access is provided, one known method of overcoming the limitations of the WPS connection is to use a Hotspot Management Software, which redirects a user to a login web page. This is, however, a somewhat unrestrictive Wi-Fi connection, which when offered without charge, is not limited to customers, but can often be accessed by anyone within the rage of the Wi-Fi network.

A known method of closing the Wi-Fi network to customers and intended users is to print an access code at the point of service. For instance, at a café, the customer may receive a receipt containing an access code which must be entered in the MS for a network connection to be established. This method requires a printer and related resources, such as paper and ink. Furthermore, these receipt-based access codes are often lengthy, sixteen digit hexadecimal codes that may be cumbersome to read or input, thereby resulting in user dissatisfaction.

### SUMMARY

A method and apparatus for establishing a remote Wi-Fi connection with WPS is disclosed, wherein an AP is connected to one or more Wi-Fi Connection Request Verifiers (“WCRV”), which allow for connection between a MS and the AP. The WCRVs comprise a display for an access code and a WPS button. To establish a connection, users must obtain an access code from the display of the WCRV and input said access code in to the MS. As an additional safety measure, users must also press a WPS button on the WCRV. Upon completion of these steps, the AP may establish a Wi-Fi connection and transmit encryption information for same.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows a configuration of multiple MSs connecting to an AP via WCRVs.

FIG. 2 shows WCRVs being placed for use at the point of service.

FIG. 3 shows a first embodiment of a WCRV.

FIG. 4 shows a second embodiment of a WCRV.

FIG. 5 shows a process flowchart for the MS.

FIG. 6 shows a process flowchart for the AP.

FIG. 7 shows a process flowchart for the WCRV.

FIG. 8 shows method for establishing a wireless network connection via remote Wi-Fi Protected Setup.

FIG. 9 shows a second method for establishing a wireless network connection via remote Wi-Fi Protected Setup.

FIG. 10 shows an apparatus for establishing a wireless network connection via remote Wi-Fi Protected Setup.

FIG. 11 shows an embodiment of an apparatus for establishing a wireless network connection via remote Wi-Fi Protected Setup, wherein the apparatus is housed within an automated queueing system.

### DETAILED DESCRIPTION

The following detailed description refers to the accompanying drawings that show, by way of illustration, specific details and aspects in which the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more.

It is appreciated that any vector and/or matrix notation utilized herein is exemplary in nature and is employed solely for purposes of explanation. Accordingly, it is understood that the approaches detailed in this disclosure are not limited to being implemented solely using vectors and/or matrices, and that the associated processes and computations may be equivalently performed with respect to sets, sequences, groups, etc., of data, observations, information, signals, etc. Furthermore, it is appreciated that references to a “vector” may refer to a vector of any size or orientation, e.g. including a 1×1 vector (e.g. a scalar), a 1×M vector (e.g. a row vector), and an M×1 vector (e.g. a column vector). Similarly, it is appreciated that references to a “matrix” may refer to matrix of any size or orientation, e.g. including a 1×1 matrix (e.g. a scalar), a 1×M matrix (e.g. a row vector), and an M×1 matrix (e.g. a column vector).

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions which will be described below in further detail may also be understood as a “circuit”. It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component comprising one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The term “button” may be used synonymously with the term “input component.” As will be described in detail, the WCRV is equipped with a button, which permits a physical contact between and end user and the WCRV. The physical contact functions largely as a security feature, as the requirement of a physical contact reduces the ability of persons who are not physically present in the vicinity of the wireless network implementation from using this wireless system. Throughout this Disclosure, this feature is referred to as a button or a Button, and it is described as being a physical or a digital button. However, this feature may also be referred to synonymously as an “input component,” since this permits an input from the user. This input could take many forms and still fulfill the security function that is created by the embodiment of the input component as a button. For example, the necessary input could be created by a variety of means, including, but not limited to, a microphone, a keyboard, a button, a slider, a fingerprint, a photograph. To the extent that this disclosure discusses a button for use on the WCRV or an input component on the WCRV, these are intended to be synonymous.

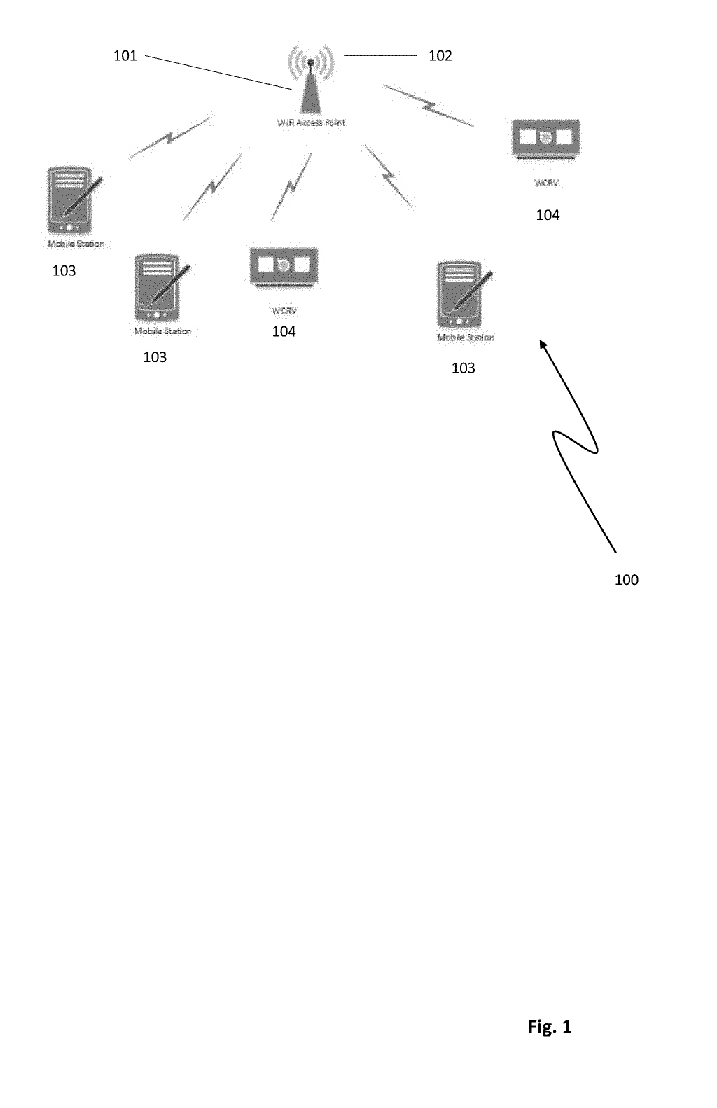

FIG. 1 shows a configuration of multiple MSs connecting to an AP via WCRVs 100. The AP 101 provides a wireless internet signal 102, which is configured to be connected via the method known as WPS. Several mobile stations 103 (collectively) are located within the range of the wireless internet signal 102 and are available for connection to the AP 101. Because some methods of WPS require close physical proximity between the MSs 103 and the AP 101, these methods may be impractical or impossible where such close physical proximity cannot be established. At least one WCRV 104 is placed within the wireless network 102 where it can be accessed by the MSs 103. The WCRV is connected to the AP via a WPS connection 105.

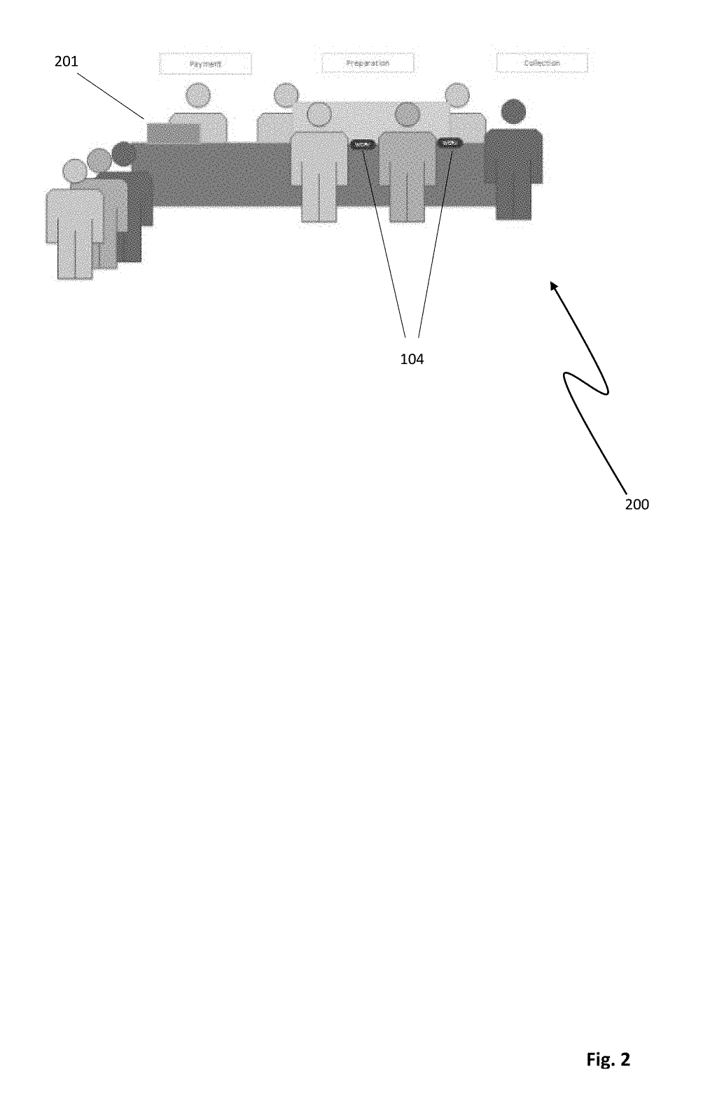

FIG. 2 shows a possible embodiment of the WCRV 104 being used to establish a WPS wireless connection in a commercial establishment 200. In this case, the at least one WCRV 104 is located near the point of service 201 to restrict access to customers.

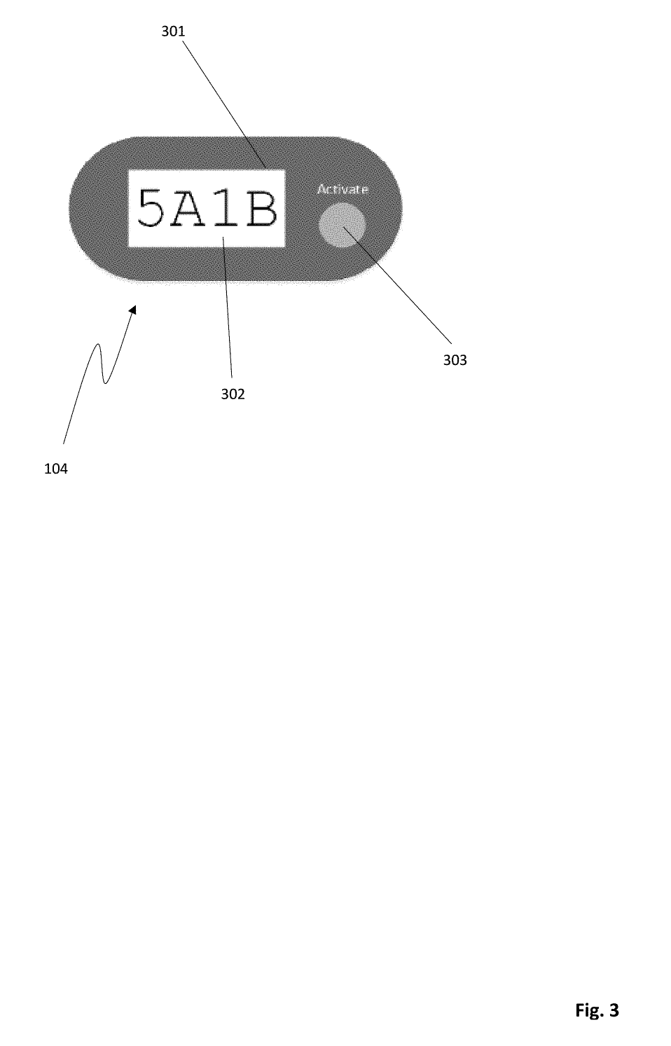

FIG. 3 shows a one embodiment of a WCRV, wherein the WCRV comprises a display 301 to communicate an access code 302 to an end user, to be entered into an MS 103. The WCRV also contains a WPS button 303, which must be pushed for a wireless connection between the MS 103 and the AP 101 to be established. In this embodiment, the WPS button 303 may also be used to accept a WPS connection signal from the AP 101, so that an initial connection between the AP and the WCRV 104 can be established. The WPS Button 303 may also be referred to in this disclosure as an input component.

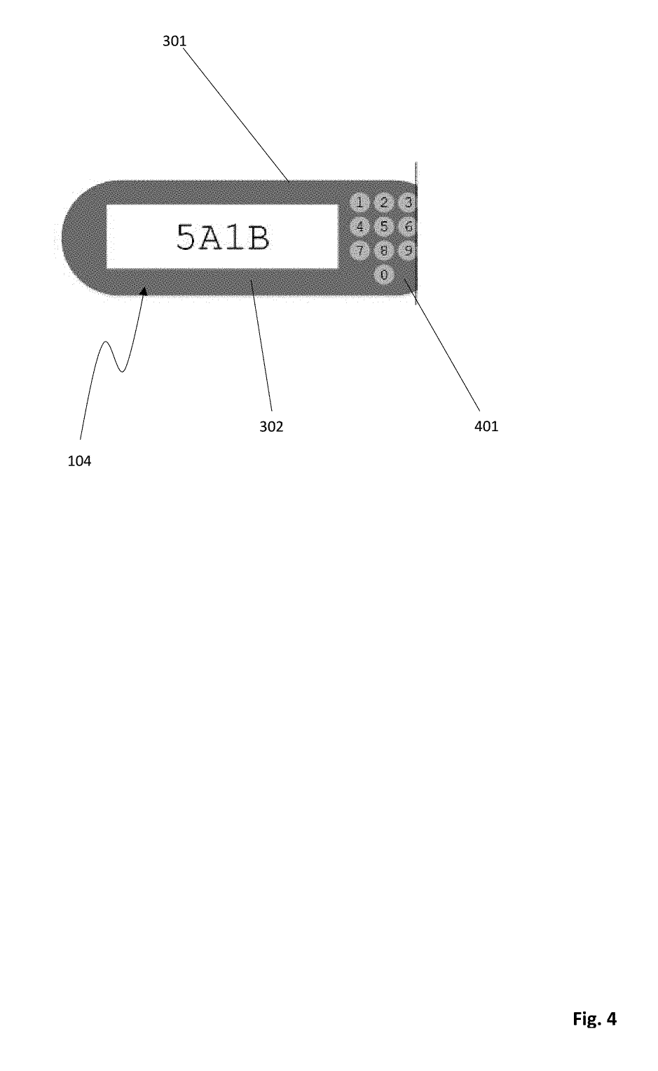

FIG. 4 shows another embodiment of the WCRV 104, wherein the WCRV 104 contains a 10-digit numerical keypad 401. Said keypad allows for connection to the AP 101 via WPS-PIN, wherein the WPS-PIN is entered into the WCRV 104 via the keypad 401. One or more buttons on the keypad 401 can also function as a WPS button, as listed as element 303. Alternatively, the WCRV 104 may be combined with both a 10-digit numerical keypad 401 and a WPS button 303, which would permit the use of a WPS-Pin to connect to the AP without needing to double a button's function to serve as a WPS button 303.

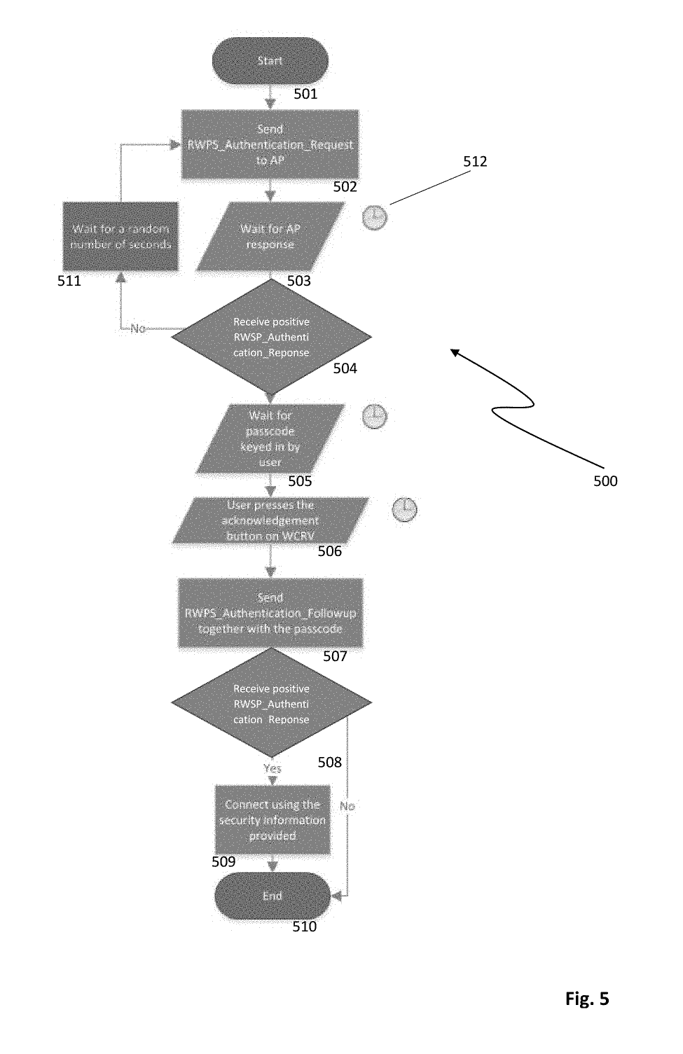

FIG. 5 shows a request flowchart 500 for the MS during the establishment of a wireless connection. To start or initiate a wireless connection 501, the MS sends a RWPS_Authorization_Request to the AP 502. The MS then waits for a response from the AP 503. If the MS receives a positive RWSP_Autentication_Respose from the AP 504, then the user must enter a passcode that is displayed on the WCRV. The MS waits until the user enters the passcode 505 and for the user to press the acknowledgement button on the WCRV 506. The MS sends a RWPS_Authorization_Followup together with the passcode 507. Upon receiving the passcode, the AP replies with a positive RWSP_Authentication_Followup_Response 508 which will also contain security information. With this security information, the MS may connect to the AP 509. Upon successful connection, the connection procedure ends 510. If in step 504, the AP does not provide a positive RWSP_Autentication_Respose, then the MS must wait for a random number of seconds 511, and then again send a RWPS_Authentication_Request to the AP 502. If in step 508, the AP does not reply with a positive RWSP_Authentication_Followup_Response, the connection process terminates 509. This figure contains various images of a clock 512 to depict steps where the MS must wait for an action to be taken.

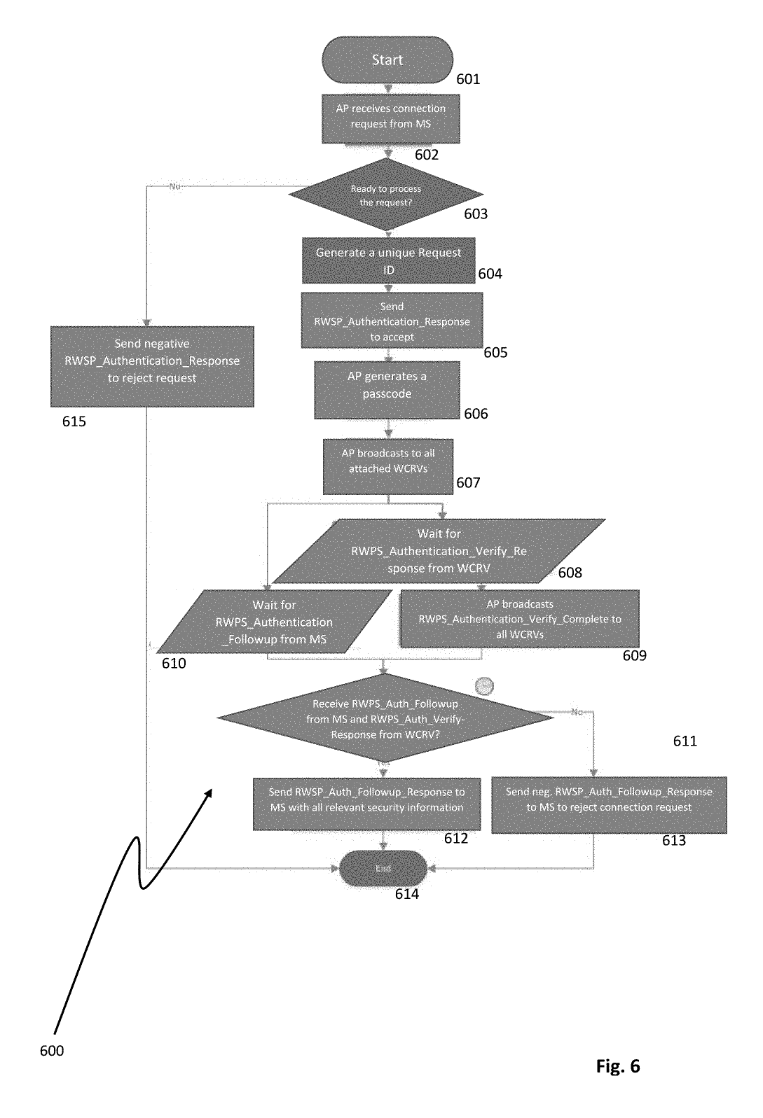

FIG. 6 shows a process flow for the AP 600. In this figure, where a connection between the MS and the AP is initiated (started) 601, the AP receives the connection request from the MS 602. The AP determines whether it is ready to process the connection request 603. When the AP is ready to process the connection request, it generates a unique Request ID 604. The AP sends an RWSP_Authentication_Response to accept the request 605. The AP then generates a hexidecimal passcode (access code) 606, which according to one embodiment is a 4-digit code. The AP broadcasts the passcode (access code) to all attached WCRVs 607. The AP then waits for a RWPS_Authentication_Verify_Response from the WCRV 608. Upon receiving the RWPS_Authentication_Verify_Response, the AP broadcasts the RWPS_Authentication_Verify_Complete signal to all WCRVs 609. Meanwhile, the AP waits for a RWPS_Authentication_Followup from the MS 610. Once the AP has received both the RWPS_Authentication_Followup from the MS and the RWPS_Authentication_Verify_Response from the WCRV 611, it will send a positive RWSP_Authentication_Folowup_Response to the MS with all relevant security information 612. Upon sending this information, the connection will be established and the process comes to an end 614. Where in step 603, the AP determines that it is not ready to process the connection request, it will send a negative RWSP_Authentication_Response to reject the request 615 and the process will come to an end 614. Where in step 611, the AP does not receive both the RWPS_Authentication_Followup from the MS and the RWPS_Authentication_Verify_Response from the WCRV 611, the AP will send a negative RWSP_Authentication_Followup_Request to the MS to reject connection request 613 and the process will come to an end 614. In step 611, a connection timer 616 is implemented, wherein, if the AP does not receive both the RWPS_Authentication_Followup and the RWPS_Authentication_Verify_Response from the WCRV within a specified period of time, the connection timer 616 will terminate the connection attempt.

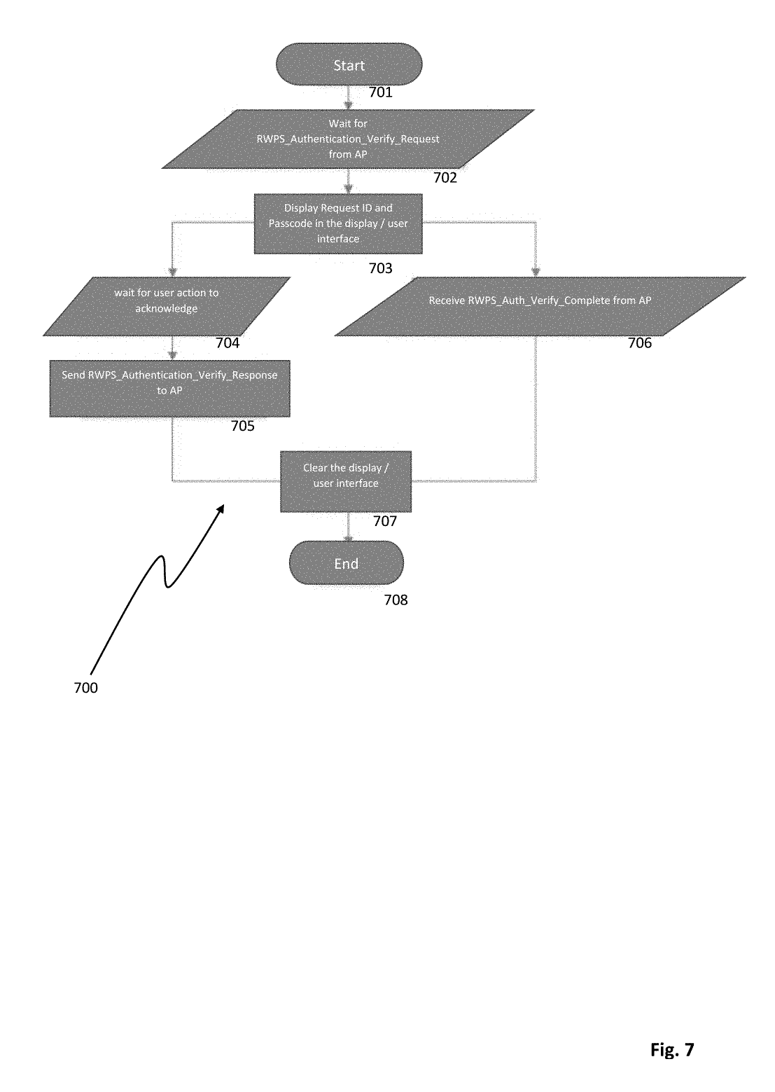

FIG. 7 shows a WCRV process flow 700. Upon being connected to the AP (start) 701, a WCRV waits for RWPS_Authentication_Verify_Request from the AP 702. A WCRV then displays the Request ID and passcode in the display or user interface of the WCRV 703. A WCRV then waits for the user action 704. Once the user action has been completed, the WCRV sends a RWPS_Authentication_Verity_Response to the AP 705. After completing these steps, and once the WCRV receives the RWPS_Authentication_Verify_Complete message from the AP 706, the displays of all WCRVs/user interfaces are cleared 707 and the process comes to an end 708.

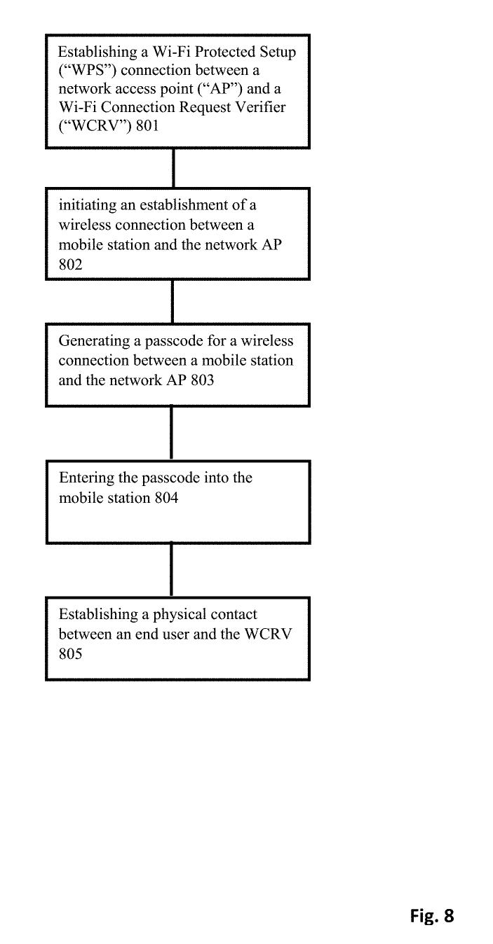

FIG. 8 shows a method for establishing a wireless network connection via remote Wi-Fi Protected Setup, comprising establishing a Wi-Fi Protected Setup (“WPS”) connection between a network access point (“AP”) and a Wi-Fi Connection Request Verifier (“WCRV”) 801; initiating an establishment of a wireless connection between a mobile station and the network AP 802; generating a passcode for a wireless connection between a mobile station and the network AP 803; entering the passcode into the mobile station 803; and establishing a physical contact between an end user and the Wi-Fi Connection Request Verifier 805.

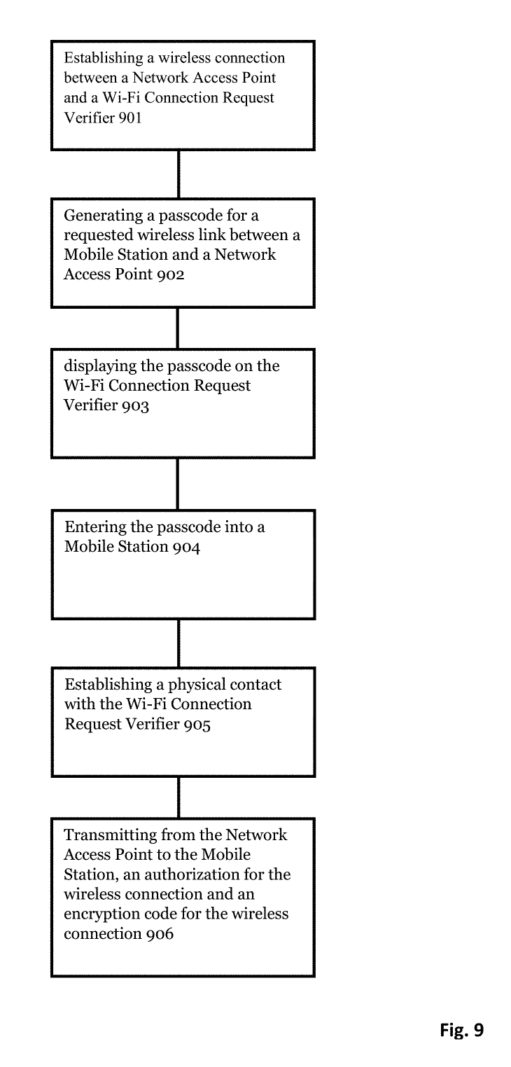

FIG. 9 shows a method for establishing a wireless network connection via remote Wi-Fi Protected Setup, comprising establishing a wireless connection between a Network Access Point and a Wi-Fi Connection Request Verifier 901; generating a passcode for a requested wireless link between a Mobile Station and a Network Access Point 902; displaying the passcode on a display located on the Wi-Fi Connection Request Verifier 903; entering the passcode into a Mobile Station 904; establishing a physical contact with the Wi-Fi Connection Request Verifier 905; and transmitting from the Network Access Point to the Mobile Station, an authorization for the wireless connection and an encryption code for the wireless connection 906.

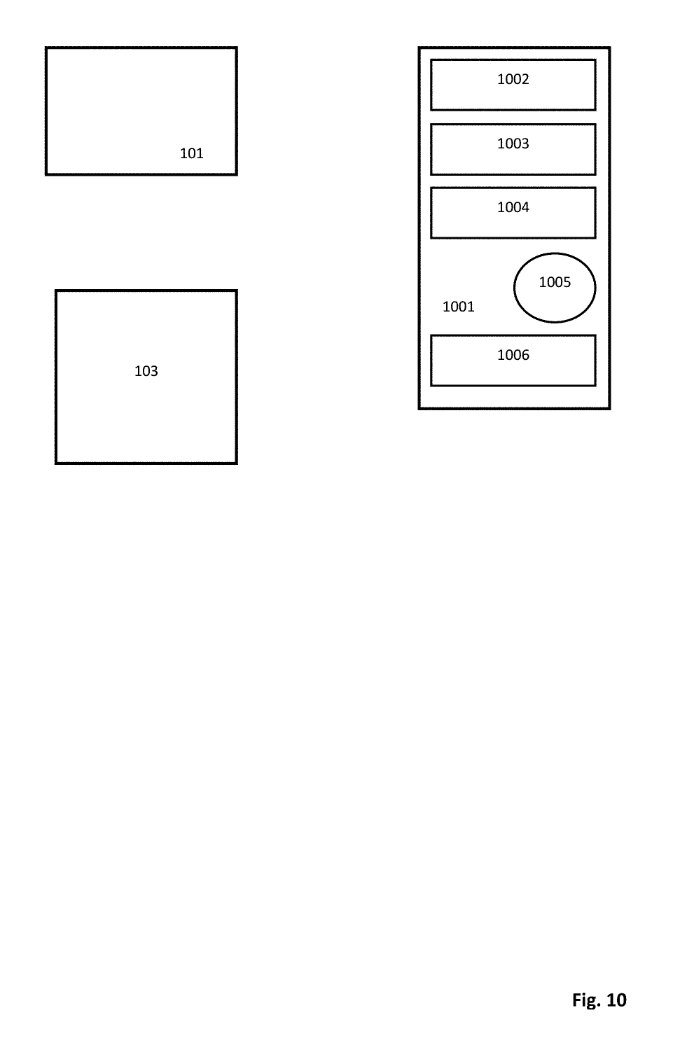

FIG. 10 shows an apparatus for establishing a wireless network connection via remote Wi-Fi Protected Setup. This apparatus comprises a Wi-Fi Connection Request Verifier 1001, which comprises a Wi-Fi modem 1002, an antenna 1003, a display 1004, at least one button 1005, and a logic circuit 1006, wherein the Wi-Fi modem 1002 is configured to transmit and receive data between a Network Access Point and a Mobile Station; the antenna 1003 is configured to facilitate transmission of data; the display 1004 is configured to display a passcode; the at least one button 1005 is configured to report a message to the Network Access Point when pressed; and the logic circuit 1006 is configured to perform a series of logical operations. In this apparatus, a Wi-Fi Protected Setup connection is established between a Network Access Point 101 and a Wi-Fi Connection Request Verifier 1001, the Network Access Point 101 generates a passcode for a wireless connection; the Network Access Point transmits the passcode to the Wi-Fi Connection Request Verifier 1001; and the Wi-Fi Connection Request Verifier displays the passcode on the display 1004. The Mobile Station 103 receives an input of the passcode from the user; the Wi-Fi Connection Request Verifier 1001 receives a confirmation of physical proximity of the user by the user pressing the button 1005; and the Network Access Point 103 transmits acceptance of the connection request and encryption information to the Mobile Station.

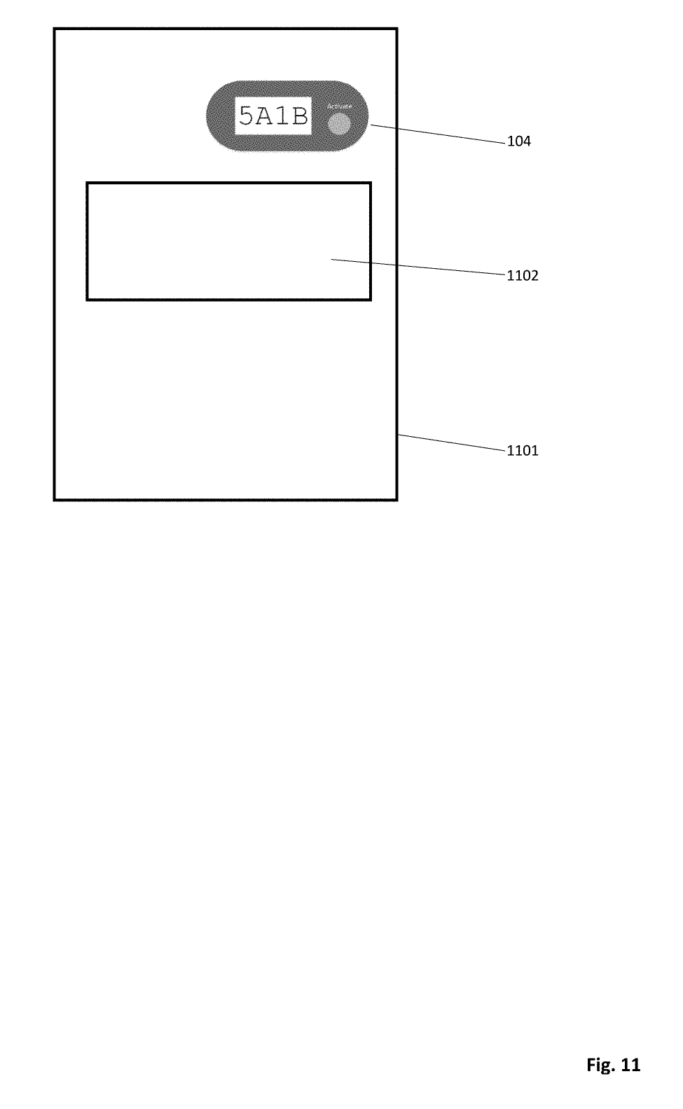

FIG. 11 shows an embodiment of the disclosure, wherein the WCRV 104 is housed within an automated queueing system not In this embodiment, the automated queueing system 1101 may comprise a screen or other means of obtaining a queueing position 1102. The WCRV 104 may be a separate device simply housed in the automated queueing system 1101, or the WCRV 104 may be incorporated into the automated queueing system 1101.

According to one aspect of the Disclosure, the WCRV permits the creation of a closed, Wi-Fi network, which is limited to a selected group of users (e.g. customers in a café, bank, etc.), and which is comparatively simple for said participants to access. Although WPS registration using a WPS connection button is a simple form of internet connection, it is impractical for wide-scale or commercial use, where the user cannot physically access the AP. For example, in a café that provides internet access, the AP may be located outside of the regular customer area, thereby making WPS connection cumbersome or impossible. Even where the AP is located in the customer area, a single AP may be limiting in terms of the area where users may stand to establish a connection. These issues are addressed by placing one or more WCRVs in the expected vicinity of the users, thereby expanding Wi-Fi access to prospective Wi-Fi users, while maintaining an amount of security.

The AP is connected to the internet, whether by a direct connection (i.e. Ethernet cable, LAN), satellite, DSL, cable, or otherwise. The AP comprises at least a transceiver, an antenna, and a controller to perform a series of logical tasks and to initiate and maintain a Wi-Fi connection via WPS. The AP can generally be located in any location, whether in the direct vicinity of the intended users, or in an area that the intended users cannot access, as long as the AP is sufficiently near, such that a wireless connection can be established and maintained between the AP, the WCRVs, and the various MSs. This may be achieved by limiting the distance between the AP, the WCRVs, and the various MSs, or by increasing the Wi-Fi signal strength, the use of boosters, or other known means.

In many installations, however, it may be most convenient to locate the AP in an area where customers are not generally permitted access. This may be in or near a dedicated computing area, such as a computer room or rack, or in an office or administration area. The AP will generally have a WPS button, to allow for ease of connection between the AP and the WCRVs.

The network will comprise at least one WCRV. The number of WCRVs is not limited, and a given network may utilize several WCRVs, as is necessary to meet user demand, or as is practical. The WCRV comprises at least a transceiver; an antenna; a controller to perform a series of logical tasks, operate a display, and to initiate and maintain a Wi-Fi connection via WPS; a display to show a passcode; and at least one button for use in establishing the WPS connection. The at least one button must be pressed by the user while establishing a WPS connection between the WCRV and the MS. The at least one button serves a role in security, as the pressing of the WPS button requires close physical proximity with the WCRV. The requirement for close physical proximity excludes physically remote users from accessing the WPS connection. For example, where a café implemented this Disclosure to provide a wireless system for its customers, a person standing outside the café would be unable to access the network, since the person would be unable to physically press the button on the WCRV. According to at least one aspect of the disclosure, the WCRV is a small Wi-Fi capable device that is capable of establishing a wireless connection. The WCRV further comprises a simple graphical user interface, whether a screen, a simple display, or otherwise. The WCRV aids the connection between the AP and the MS by communicating to the user a WPS key and by verifying the physical presence of the user. According to one aspect of the disclosure, the at least one button can serve dual purposes of acknowledging an MS request for a wireless connection with the AP, and also to support a WPS-connection with the AP. According to another aspect of the disclosure, there can be at least two buttons on the WCRV. Of these, one button will acknowledge the request for a new connection between the MS and the AP. The other button will be to support the WPS function. For example, this may be used to support the connection between the AP and the WCRV.

As described above, the WCRV comprises at least one button, which adds a level of security by requiring a physical presence of a user for a network connection to be established. This button may be referred to as a “button” or an “input component,” throughout this disclosure. These terms are intended to be synonymous for the purposes of this disclosure. The input component term is used to signify that the physical presence of the user can be established by other means than simply pressing a button. For example, the user could signify a physical presence, by performing a sliding movement or engaging a slider; giving a thumbprint, fingerprint, or handprint; turning, twisting, pushing, or pulling a device; speaking into a microphone; pressing one or more keys on a keyboard; taking picture; or causing a flash to occur. Although the term input component is used to clarify that the physical presence of the user can be confirmed through more methods than merely pushing a button, where the term “button” is used with respect to the WCRV, this term is intended to have the breadth of meaning given to the term “input component” and should be understood to contemplate and comprise each of the aforementioned means to confirm a user presence.

As a further measure to restrict the network to the intended users, the WCRVs can be placed by the point of sale. For example, at a café, there may be a wait of up to several minutes between ordering and obtaining a beverage. Under these circumstances, customers may form a line between a register where the order is taken, and the point where a beverage is picked up. According to one aspect of the Disclosure, WCRVs may be placed in locations convenient to this line, such that they are easily accessible by customers. In an environment such as a café, the intended users are a subset of the customers, and it may be desirable to place the WCRVs in a location that allows easy access by customers and discourages use by other persons (i.e. unintended users, non-customers). Placing the WCRVs along the line between the point of sale and product pickup reduces the chance of unintended users accessing the wireless connection, since unintended users may be less likely to physically approach the cafés employees, the register, and/or the other customers, to see an unauthorized connection to the wireless network. Such a configuration may be adapted to other settings, including, but not limited to restaurants, banks, post offices, waiting rooms, government services offices, cafeterias, etc.

The ability for WCRVs to maintain a wireless connection to the AP supports the AP's ability to be located beyond customer access. The WCRVs can be stand-alone devices or incorporated into other devices in a commercial setting, such as registers or displays. The ability of the WCRV to create a point of user interaction with the wireless network frees the AP from direct user interaction and thereby obviates the need for aesthetically attractive housing or user-friendly buttons or displays.

The WCRVs are configured to connect to a variety of APs and will comprise at least a transceiver, an antenna, and a controller to carry out a set of logical sequences and establish a wireless connection.

According to one aspect of the Disclosure, the WCRV will connect to the AP via Wi-Fi Protected Access (“WPA”) or Wi-Fi Protected Access II (“WPA2”). According to another aspect of the Disclosure, the WCRVs may establish a connection with the APs using any system that is customary or approved for use at that time. The WCRV is expressly contemplated as being capable of utilizing other standards of wireless connection, as well as adapting to changes in standards for wireless connection, such as future iterations of the WPA standard, or new standards altogether.

According to one aspect of the Disclosure, the MS initiates a connection to the AP. Under this circumstance, the MS initiates a connection with the AP, and the AP generates a request ID. The AP generates a passcode for the wireless connection and transmits this passcode to the WCRV. The WCRV displays the passcode on a screen or display. This may be a monitor, a projector, a television screen, a LED display, or any other type of screen that is capable of displaying a series of numbers. The MS receives an acknowledgement of the connection request, and the MS displays a screen that permits the passcode to be entered on the MS. The user must enter the passcode on the mobile device and press a button on the WCRV. As described above, the button on the WCRV confirms the physical presence of the user in the vicinity of the WCRV. Upon successful entry of the passcode in the MS, and upon pressing the button on the WCRV, the connection between the AP and the MS can be established. For added security, the AP transmits encryption information to the WP, which is then used in maintaining a secure transmission.

According to another aspect of the Disclosure, the AP establishes the connection request. In accordance with this aspect, the AP also generates the request ID. As in the prior aspect, the AP generates a passcode, which is then displayed on the WCRV. A user desiring the connect an MS to the wireless network will input the passcode into the MS and press the button on the WCRV.

The process of establishing a wireless connection requires that the WCRV is first wirelessly connected to the AP. According to one aspect of the Disclosure, this connection is established using a WPS-button located on the AP. This method follows the regular protocols of establishing a wireless connection using WPS. Generally, the WPS-button on the AP is pressed, which instructs the AP to search for other, nearby devices with which to connect. A wireless connection is then established between the AP and a WCRV. This process may be repeated to establish a connection for each of the various WCRVs that may be desired for a given installation. This process may be utilized regardless of whether the WCRVs are in a fixed location or moveable, as long as the WCRVs are sufficiently close to the AP to communicate within the same wireless Wi-Fi network.

According to another aspect of the Disclosure, the connection between the AP and the WCRV is established via Wi-Fi Protected Set-Up Near Field Communication (“WPS-NFC”). Under this method, the WCRV is physically transported into close proximity with the AP. Circuity within the AP and the WCRV, such as RFID tags, may establish a connection between the AP and the WCRV and thereby establish an ongoing wireless link. After said link is established, the WCRV can then be returned to the location of its anticipated use.

According to another aspect of the Disclosure, the connection between the AP and the WCRV is established via WPS-PIN. In this method, the AP has a PIN, which must be entered on the WCRV to establish the connection. In many installations, this is a 16-digit hexadecimal code, although the PIN may be any length, and the length of the PIN may be increased or shortened as desired. The PIN may be a static number that is saved within the circuitry or memory of the AP. The PIN may be changed periodically for security purposes. Wireless Wi-Fi connection between the AP and the WCRV proceeds upon successful entry of the PIN.

After a wireless Wi-Fi connection is established between the AP and the WCRVs, MSs may establish a wireless connection to the AP using the WCRVs. According to one aspect of the Disclosure, the wireless connection is created using a passcode that is generated by the AP. In one embodiment of the Disclosure, the passcode is a 4-digit, hexadecimal passcode. Because the passcode is generated following, or in response to, a connection request, the passcode is expected to only be valid for a single connection request and therefore to change with significant frequency. The changing passcode allows for increased security compared to systems where the passcode for MS access is fixed or changed infrequently. Moreover, because the passcode is limited to the duration of a particular wireless connection request, and because it must be used in combination with physical connection to WCRV, the passcode is less-sensitive to brute force attacks than a static code or a code that does not require physical contact with the WCRV. Therefore, it is reasonable to employ shorter passcodes, such as a 4-digit passcode, than may otherwise be desirable in other environments. This simplifies entry of the passcode compared to other systems of printing lengthy passcodes. Furthermore, because the passcode is displayed on the WCRV, which may be located in a setting that is only readily available to intended users (e.g. customers), the WCRV further reduces the ability of non-intended-users to access the wireless network.

Alternatively, the passcode for the connection between the MS and the WCRV can be a hexadecimal number greater than or less than 4 characters. According to one aspect of the Disclosure, the passcode is longer than 4-digits. Longer passcodes are associated with greater security and may therefore be desirable. Longer passcodes may make it more difficult for a non-intended-user to observe a WCRV from a distance and attempt to enter a passcode. Similarly, longer passcodes may reduce the success of a brute force attack. A longer passcode may be any number greater than 4-digits. According to one embodiment, the passcode is 8-digits. According to another embodiment, the passcode is 12-digits. According to another embodiment, the passcode is 16-digits. According to another embodiment, the passcode is greater than 16-digits.

According to another aspect of the Disclosure, a passcode shorter than 4-digits may be desirable. Although shorter passcodes are thought to be less secure, a short passcode may be desirable under some circumstances. For example, where intended users have limited time to enter a passcode, such as in a line at a café, shorter passcodes may be more desirable than lengthy passcodes. This may also hold true in environments where the ability to enter a passcode is hampered by the availability of only one hand, such as where customers must carry an item or handle payment for goods or services during the time available to enter the passcode. Presbyopic users may require additional time to read and enter a passcode, and therefore shorter passcodes may be more desirable.

According to another aspect of the Disclosure, the wireless connection may be established via a WPS-NFC connection between the MS and the WCRV. In this embodiment, and after a connection request is established, the user places the MS in close proximity, or even in direct connection with, the WCRV. The connection is established via WPS-NFC, and this connection satisfies the requirement of physical connection between the user and the WCRV that is normally fulfilled through pushing a button on the WCRV. Once this requirement has been fulfilled, the wireless connection between the MS and the AP can be approved. The location of the WCRV simplifies the connection between the MS and the AP by removing the requirement for the MS to be in close physical proximity to the AP, which may be inconvenient or impossible in a number of settings.

According to one aspect of the Disclosure, the WCRV may have a business logo printed on its physical structure. The addition of the business logo may communicate to users that they are using a wireless network that is provided by the business that they are patronizing. Said logo may inspire additional trust in the network connection and/or the WCRV by marking the devices that are part of the business's trusted network. Said logo may distinguish the wireless network from an imposter network and eliminate confusion and deter fraud, where a third-party places a device in the vicinity of the WCRV, with the intent of mimicking the business's network.

The requirements of a passcode and the pressing of a button (or in the case of the NFC embodiment, the close physical proximity between the MS and the WCRV) create a closed Wi-Fi network that can be used to limit access to a desired group of intended users (e.g. customers). This is in contrast to an unrestricted connection that does not limit the users. This is also in contrast to certain implementations of Hotspot Management Software, which may allow anyone physically located within the Wi-Fi network to establish a wireless Wi-Fi connection, even if said person is not an intended user.

According to one aspect of the Disclosure, the wireless Wi-Fi connection is encrypted. In establishing a wireless connection, the AP transmits security information, such as encryption codes, to the MS for use during the wireless connection. This encryption connection can be used to carry out ongoing, secure communication between the AP and the WS. This may be especially desirable in environments with multiple users in close proximity, such as a café.

It is also known that some establishments that provide Wi-Fi access may allow for, or even encourage, transactions of sensitive information. For example, Wi-Fi access is offered in certain banking establishments. By virtue of being in a bank, Wi-Fi users may perform financial transactions of a sensitive nature, where a secure network connection is preferable. Banks or other institutions that provide Wi-Fi access may even encourage users to perform transactions of a sensitive nature online. Under these circumstances, and even generally while exercising due caution for security, a secure, encrypted wireless connection may be preferable.

According to one aspect of the Disclosure, the wireless connection is encrypted via WPA or WPA2. It is also expressly contemplated that the wireless connection may be encrypted via Extensible Authentication Protocol (“EAP”). As other encryption technologies become available or desirable, the Disclosure may offer these various encryption technologies to offer ongoing, secure, wireless connections. The AP is contemplated to accept and utilize additional encryption methods as they become known or available.

According to another aspect of the Disclosure, the WCRV may be integrated into a queueing system. In many institutions, a queueing system is implemented to accommodate customers and create an order to fairly accommodate limited service resources. For example, customers entering a bank or a government office may be instructed to approach an automated queueing system, where they press a button and receive a ticket with a number that corresponds to a place in a line to receive service. The WCRV may be integrated into such an automated queuing system, such that the system that produces a number for a place in line also comprises a WPS-button and a display to show a passcode to establish a wireless connection with the AP.

According to another aspect of the Disclosure, the WCRV comprises a display that is capable of displaying an alpha-numeric data combination. The display may be a computer screen, a monitor, a television screen, a tablet screen, or a simple LED screen, or any other screen that is capable of showing numbers and letters. Where only a screen capable of displaying number or letters is available, the passcode can be further restricted to accommodate that limitation. The display may be made small, so as to reduce the ability for distant, non-intended users (i.e. non-customers outside of a bank or a café) to read and coopt a displayed passcode. Alternatively, the display may be made larger to simplify reading and copying of the passcode. An embodiment with a larger screen may be particularly useful where the intended users are presbyopic.

According to another aspect of the Disclosure, the WCRV is equipped with a button to perform a WPS connection with the MS. This may be a physical button that is capable of being pushed or otherwise activated by the user. Alternatively, this may be a digital button, such as a button on a touch-sensitive display.

According to another aspect of the Disclosure, the WCRV is further equipped with a 10-digit keypad. This keypad can be used to enter a WPS-PIN to establish connection between the WCRV and the AP. The WPS button used in the establishment of a connection between the MS and the WCRV may be positioned in the WCRV in addition to the 10-digit keypad. Alternatively, one or more buttons that comprise the 10-digit keypad may be selected to perform both the functions of the 10-digit keypad during the establishment of the link between the AP and the WCRV, and also a WPS-button during the establishment of a link between the MS and the WCRV.

According to another aspect of the Disclosure, all WCRV devices are connected to the AP using a method of WPS. In many installations, a wireless connection between the at least one WCRV and the AP will be preferred. Where a wireless connection is desirable, the simplicity of a WPS connection (whether WPS-button, WPS-NFC, or WPS-PIN) may be desirable.

According to another aspect of the Disclosure, a wired connection between the WCRV and the AP could be used. This would permit the transmission of passcodes, confirmation of the user having pressed the WPS button, and any other requests, confirmation, acknowledgements, or signals otherwise necessary to establish a wireless connection between the AP and the WS via a dedicated or fixed line.

According to one embodiment, the AP sends a passcode to all WCRVs. In this embodiment, all WCRVs will display the same passcode at any given time. Where there are multiple WCRVs, a user may obtain the passcode from any WCRV. Similarly, the user may push the WPS button of any WCRV. In this way, the multiple WCRVs serve primarily a role of convenience, wherein the they display the passcode in multiple locations, and they provide multiple WPS buttons. According to this embodiment, the AP and WCRVs are configured to respond to only one user wireless network connection request at a time.

Where the AP and WCRVs are configured to respond to only one user wireless network connection request at a time, AP and WCRVs will process only one connection request at a time. Where, for example, two potential users each approach different WCRVs and each initiate a connection request at approximately the same time, only one user's request will be initially processed. The AP will transmit a passcode to the WCRVs, where the passcode will be projected to both prospective users. However, only one prospective user will obtain a screen on the user's device/MS to input the passcode. Upon the first user entering the passcode, pressing the WPS-button and establishing a connection, the second user's request can be addressed. Furthermore, in the event that more than one MS were to be able to input the same passcode, the AP will only grant a wireless connection to the MS with an MS identifier that corresponds to the pending Request ID.

Where the WCRV and the AP are configured to only address one connection request at a time, potential users who desire a wireless connection may be prejudiced by the inaction of a user whose request is being processed by the AP. For instance, where two prospective users request a wireless connection at approximately the same time, and one prospective user's MS displays a screen for inputting the passcode from the WCRV, the other prospective user's request will be placed in abeyance until the first user's request is resolved or terminated. Where the first prospective user then delays completion of the connection request (e.g. where the prospective user fails to input the passcode or press the WPS-button on the WCRV), the second prospective user could be precluded from establishing a wireless connection for a lengthy time. To eliminate this undesirable outcome, a timer is disclosed to automatically deny and terminate a new connection request that remains incomplete, upon expiration of a specified time limit. That is, upon initiating a new connection request, a timer of a specified length will begin to run, and at the completion of said timer, and where either the passcode has not been entered in the MS, or the WPS-button has not been pushed, the new connection request will be terminated. Where a pending connection request is being held in abeyance during the consideration of a new connection request, and where the new request is terminated by the timer, the AP will turn to the pending request in abeyance and begin to process same.

According to one embodiment, the new connection request timer is 10 seconds from the initiation of a new connection request. According to a second embodiment, the new connection request timer is 20 seconds from the initiation of a new connection request. The new connection request timer may be set to any length, and it may be adjusted repeatedly to address the needs of any given installment.

According to another embodiment, the AP directs individual passcodes to the various WCRVs. Where a WPS-button is pressed on a given WCRV, the AP may direct a passcode to said WCRV, and upon the user entering said passcode, the connection between the WS and the AP will be established.

According to one aspect of the Disclosure, once a passcode is transmitted to a WCRV, the passcode is entered into a MS, and a WPS-button is pushed on a WCRV, the AP transmits the RWPS_Authentication_Verify_Complete message to all WCRVs displaying that code. Upon receiving this message, these WCRVs' screens will reset, such that the used passcode no longer appears.

According to one embodiment, the user initiates a new connection request by placing the MS in close proximity to the WCRV and pushing the WPS-Button.

The following examples pertain to various embodiments of the Disclosure:

In Example 1, a method adapted to establish a remote connection is disclosed, comprising:
establishing a Wi-Fi Protected Setup (“WPS”) connection between a network access point (“AP”) and a Wi-Fi Connection Request Verifier (“WCRV”);
generating a passcode for a wireless connection between a mobile station and the network AP;
entering the passcode into the mobile station; and
establishing a physical contact between an end user and the Wi-Fi Connection Request Verifier.

In Example 1(a), the method of Example 1 is disclosed, further comprising displaying the passcode on the WCRV.

In Example 1(b), the method of Example 1 is disclosed, further comprising initiating a wireless connection between a mobile station and a network AP.

In Example 1(c), the method of Example 1 is disclosed, further comprising establishing a wireless connection between a mobile station and the network AP.

In Example 2, a method for establishing a wireless network connection via remote Wi-Fi Protected Setup is disclosed, comprising:
establishing a wireless connection between a Network Access Point (“AP”) and a Wi-Fi Connection Request Verifier (“WCRV”);
generating a passcode for a requested wireless link between a Mobile Station and a Network Access Point;
displaying the passcode on the Wi-Fi Connection Request Verifier;
entering the passcode into a mobile station;
establishing a physical contact with the Wi-Fi Connection Request Verifier;
and transmitting from the Network Access Point to the Mobile Station, an
authorization for the wireless connection and an encryption code for the wireless connection.

In Example 3, the method of Example 1 or 2 is disclosed, further comprising establishing the wireless connection between the Network Access Point and the Wi-Fi Connection Request Verifier by any one of entering a Wi-Fi Protected Service PIN into the Wi-Fi Connection Request Verifier; bringing the Wi-Fi Connection Request Verifier into close physical proximity to the Network Access Point and engaging a Wi-Fi Protected Connection Near Field Communication circuit; or pushing a Wi-Fi Protected Setup button on the Network Access Point.

In Example 4, the method of any one of Examples 1 to 3 is disclosed, wherein the connection between the AP and the WCRV is established via WPS-Button.

In Example 5, the method of any one of Examples 1 to 3 is disclosed, wherein the connection between the AP and the WCRV is established via WPS-NFC.

In Example 6, the method of any one of Examples 1 to 3 is disclosed, wherein the connection between the AP and the WCRV is established via WPS-PIN.

In Example 7, the method of any one of Examples 1 to 3 is disclosed, wherein at least two WCRV devices are connected to the access point via WPS.

In Example 8, the method of Example 1, 2, or 4 is disclosed, wherein pushing a WPS-button on the AP triggers a WPS connection process between the WCRV and the AP.

In Example 9, the method of Examples 1, 2, or 3 is disclosed, further comprising the wireless connection between the Network Access Point and the Mobile Station being established by bringing the Wi-Fi Connection Request Verifier into close physical proximity to the Network Access Point and engaging a Wi-Fi Protected Connection Near Field Communication circuit (“NFC”).

In Example 10, the method of any one of Examples 1, 2, or 3 is disclosed, further comprising establishing a Wi-Fi Protected Setup connection between the AP and at least two WCRVs.

In Example 11, the method of Examples 1 or 2 is disclosed, wherein the connection between the Mobile Station and the AP is established via WPS-Button.

In Example 12, the method of Examples 1, 2, or 11 is disclosed, wherein the connection between the AP and the Mobile Station is established via WPS-NFC connection.

In Example 13, the method of Examples 1 or 2 is disclosed, wherein the connection between the AP and the Mobile Station is established via WPS-PIN.

In Example 14, the method of Example 1 or 2 is disclosed, wherein the MS initiates a connection request (RWPS_Authentication_Request).

In Example 15, the method of Examples 1 or 2 is disclosed, wherein the AP sends a RWSP_Authenticaiton_Response to the MS.

In Example 16, the method of Examples 1 or 2 is disclosed, wherein the AP sends to a WCRV a public key for encryption.

In Example 17, the method of Example 1 or 2 is disclosed, wherein the AP sends an RWPS_Authentication_Vertify_Request to the WCRV.

In Example 18, the method of Example 1 or 2 is disclosed, wherein the AP sends an RWPS_Authentication_Vertify_Request to the MS.

In Example 19, the method of Example 1 or 2 is disclosed, wherein a RWPS_Authentication_Vertify_Request is transmitted with a request_ID and passwords.

In Example 20, the method of Example 1 or 2 is disclosed, wherein the WCRV sends a RWPS_Authentication_Verifty_Response is sent to the AP.

In Example 21, the method of Example 1 or 2 is disclosed, wherein the RWPS_Authentication_Verifty_Response is sent with a Request_ID and passcode.

In Example 22, the method of Example 1 or 2 is disclosed, wherein the AP broadcasts an RWPS_Authentication_Verify_Complete to all WCRVs.

In Example 23, the method of Example 22 is disclosed, wherein the RWPS_Authentication_Verify_Complete causes a WCRV to reset its screen.

In Example 24, the method of Example 1 or 2 is disclosed, wherein the MS sends a RWPS_Authentication_Followup to the AP.

In Example 25, the method of Example 1 or 2 is disclosed, wherein a user enters a passcode on the MS.

In Example 26, the method of Example 25 is disclosed, wherein the passcode is transmitted with a RWPS_Authentication_Followup.

In Example 27, the method of Example 1 or 2 is disclosed, wherein the AP sends the RWSP_Authentication_Followup_Response to the MS.

In Example 28, the method of Example 1 or 2 is disclosed, wherein the user inputs an incorrect passcode in the MS.

In Example 29, the method of Example 28 is disclosed, wherein the incorrect passcode causes the AP to deny the connection request.

In Example 30, the method of Example 1 or 2 is disclosed, wherein the connection button on the WCRV is not pressed within a predetermined period of time after the connection request is initiated.

In Example 31, the method of Example 30 is disclosed, wherein the AP denies the connection request at the expiration of the predetermined period of time.

In Example 32, the method of Example 1 or 2 is disclosed, wherein the no passcode is entered in the MS within a predetermined period of time after the connection request is initiated.

In Example 33, the method of Example 32 is disclosed, wherein the AP denies the connection request at the expiration of the predetermined period of time.

In Example 34, the method of any one of Examples 30 to 33 is disclosed, wherein the AP sends a negative response to end the connection request.

In Example 35, the method of Example 1 or 2 is disclosed, wherein the AP processes only one connection request at a time.

In Example 36, the method of Example 1, 2, or 35 is disclosed, wherein at least 1 user attempts to establish a wireless connection before another connection request is accepted or terminated.

In Example 37, the method of Example 1, 2, or 36 is disclosed, wherein one MS will display a screen to input the access code at a given time.

In Example 38, the method of any one of Example 1 or 2 or 30 to 33 is disclosed, wherein a connection timer limits the time to establish a wireless connection after initiating a connection request.

In Example 39, the method of Example 1, 2, or 38 is disclosed, wherein the connection timer begins to run upon the initiation of a connection request.

In Example 40, the method of Example 38 is disclosed, further comprising a pending connection request which has not resulted in a wireless connection being terminated due to expiration of the connection timer.

In Example 41, the method of Example 38 or 40 is disclosed, wherein the connection timer runs for ten seconds before expiring.

In Example 42, the method of Example 38 or 40 is disclosed, wherein the connection timer runs for twenty seconds before expiring.

In Example 43, the method of Example 38 or 40 is disclosed, wherein the duration of the connection timer can be set to accommodate factors related to the wireless internet installation.

In Example 44, the method of Example 43 is disclosed, wherein the factors related to the wireless internet installation comprise any of the number of potential users, the density of potential users, the frequency of connection requests, and/or the availability of WCRVs.

In Example 45, the method of Example 1 or 2 is disclosed, wherein the AP is configured to receive and respond to multiple connection requests at one time.

In Example 46, the method of Example 1 or 2 is disclosed, wherein it is necessary to press a button on the WCRV to initiate a wireless connection.

In Example 47, the method of Example 1 or 2 is disclosed, wherein it is necessary to press a button on the WCRV to establish a wireless connection.

In Example 48, the method of Example 46 or 47 is disclosed, wherein the requirement to press a button on the WCRV restricts access to intended users.

In Example 49, the method of Example 48 is disclosed, wherein the restriction of access to intended users provides increased safety to the users of the wireless network.

In Example 50, the method of any one of Examples 46 to 48 is disclosed, wherein the requirement to press a button on the WCRV to establish a network connection reduces the risk of a non-intended user accessing the wireless network.

In Example 51, the method of Example 1 or 2 is disclosed, further comprising the network access point being connected to at least two Wi-Fi Connection Request Verifiers.

In Example 52, the method of Example 51 is disclosed, wherein the passcode is displayed on the at least two Wi-Fi Connection Request Verifiers.

In Example 53, the method of Example 1 or 2 is disclosed, wherein the physical contact between the end user and the Wi-Fi Connection Request Verifier is the end user pushing a button on the Wi-Fi Connection Request Verifier.

In Example 54, the method of Example 53 is disclosed, wherein a physical push-button on the WCRV must be pressed to establish a network connection.

In Example 55, the method of Example 53 is disclosed, wherein a digital button on the WCRV must be pressed to establish a network connection.

In Example 56, the method of Example 55 is disclosed, wherein the button is on a touch-screen.

In Example 57, the method of Example 1 or 2 is disclosed, further comprising a window for entry of the passcode appearing on a screen of the mobile station in requires to a request for a wireless connection.

In Example 58, the method of Example 1 or 2 is disclosed, further comprising the Network Access Point receiving a wireless connection request from the Mobile Device, and the Network Access Point creating a unique request ID in response.

In Example 59, the method of Example 1 or 2 is disclosed, wherein the passcode is displayed on the WCRV.

In Example 60, the method of Example 59 is disclosed, wherein the passcode is 4 digits.

In Example 61, the method of Example 59 is disclosed, wherein the passcode is 8 digits.

In Example 62, the method of Example 59 is disclosed, wherein the passcode is 12 digits.

In Example 63, the method of Example 59 is disclosed, wherein the passcode is 16 digits.

In Example 64, the method of Example 59 is disclosed, wherein the length of the passcode displayed on the WCRV can be adjusted by the administrator of the wireless network.

In Example 65, the method of any one of Examples 59 to 64 is disclosed, wherein the passcode is a hexadecimal code.

In Example 66, the method of any one of Examples 59 to 65 is disclosed, wherein the passcode displayed on the WCRV is randomly generated.

In Example 67, the method of any one of Examples 59 to 66 is disclosed, wherein both the passcode and a user ID are displayed on the WCRV.

In Example 68, the method of any one of Examples 59 to 66 is disclosed, wherein both the passcode and a request ID are displayed on the WCRV.

In Example 69, the method of any one of Examples 59 to 66 is disclosed, wherein only the passcode is displayed on the WCRV.

In Example 70, the method of Example 1 or 2 is disclosed, wherein the wireless connection between the MS and the AP is established only after entering the passcode on the MS and pressing the button on the WCRV.

In Example 71, the method of any one of Examples 59 to 66 is disclosed, further comprising displaying the passcode on the at least two Wi-Fi Connection Request Verifiers.

In Example 72, the method of Example 1 or 2 is disclosed, further comprising the network access point transmitting an acceptance of the wireless connection request.

In Example 73, the method of Example 1 or 2 is disclosed, wherein the connection between the MS and the AP is encrypted.

In Example 74, the method of Example 1 or 2 is disclosed, further comprising the network access point transmitting an encryption information to the mobile station.

In Example 75, the method of Example 73 is disclosed, further comprising the Mobile Station and the Network Access Point employing the encryption information to establish a secure connection between the network access point and the mobile station.

In Example 76, the method of Example 1 or 2 is disclosed, wherein the Wi-Fi connection is a closed wireless connection.

In Example 77, the method of any one of Examples 73 to 76 is disclosed, wherein the encryption creates a secure wireless connection.

In Example 78, the method of Example 77 is disclosed, wherein the level of security offered by an encrypted connection is preferable in public Wi-Fi installations.

In Example 79, the method of any one of Examples 73 to 76 is disclosed, wherein the Wi-Fi is encrypted with Wi-Fi Protected Access.

In Example 80, the method of any one of Examples 73 to 76 is disclosed, wherein the Wi-Fi is secured with Wi-Fi Protected Access or Wi-Fi Protected Access II.

In Example 81, the method of any one of Examples 73 to 76 is disclosed, wherein the Wi-Fi is encrypted with Extensible Authentication Protocol.

In Example 82, the method of any one of Examples 73 to 76 is disclosed, wherein the AP and WCRV are configured to function with future methods and versions of encryption software.

In Example 83, the method of Example 1 or 2 is disclosed, wherein the method is employed at a retail establishment.

In Example 84, the method of Example 1 or 2 is disclosed, wherein the method is employed at a bank.

In Example 85, the method of Example 1 or 2 is disclosed, wherein the WCRV is integrated into a queue system or ticket printer.

In Example 86, An apparatus adapted to establish a wireless network connection via remote Wi-Fi Protected Setup is disclosed, the apparatus comprising:
a Wi-Fi modem to transmit and/or receive data between a Network Access Point and a Mobile Station;
an input component configured to report a message to the Network Access Point when engaged; and
a logic circuit to:
establish a Wi-Fi Protected Setup connection with a Network Access Point;
receive a passcode from the Network Access Point;
and report an acknowledgement to the Network Access Point upon the input component being pressed.

In Example 86(a), the Apparatus of Claim 86 is disclosed, further comprising a display configured to display a passcode.

In Example 87, an apparatus for establishing a wireless network connection is disclosed, said apparatus comprising, a Network Access Point, further comprising a transceiver, an antenna, and a controller; a WCRV, further comprising a transceiver, an antenna, a controller, a display, and a button; and a mobile station, further comprising, a transceiver, an antenna, and a controller; wherein a WPS connection is established between an AP and a WCRV; the AP generates a passcode for a wireless connection; the AP transmits the passcode to the WCRV; the WCRV displays the passcode; the MS receives input of the passcode from the user; the WCRV receives a confirmation of physical proximity of the user; and the AP transmits encryption information to the mobile station.

In Example 88, an apparatus for establishing a wireless network connection via remote Wi-Fi Protected Setup is disclosed, said apparatus comprising:
a Wi-Fi Connection Request Verifier is disclosed, further comprising a Wi-Fi modem,
an antenna, a display, a button, and a logic circuit, wherein:
the Wi-Fi modem is configured to transmit and receive data between a Network Access Point and a Mobile Station;
the antenna is configured to facilitate transmission of data;
the display is configured to display a passcode;
the button is configured to report a message to the Network Access Point when pressed; and
the logic circuit is configured to perform a series of logical operations;
wherein a Wi-Fi Protected Setup connection is established between a Network Access Point and the Wi-Fi Connection Request Verifier;
the Network Access Point transmits a passcode to the Wi-Fi Connection Request Verifier;
the Wi-Fi Connection Request Verifier displays the passcode;
the Mobile Station receives input of the passcode from the user;
the Wi-Fi Connection Request Verifier receives a confirmation of physical proximity of the user;
and the Network Access Point transmits encryption information to the Mobile Station.

In Example 89, the apparatus of Claim 86, 87, or 88 is disclosed, further comprising the Wi-Fi Connection Request Verifier being housed within an automated queueing system.

In Example 90, the apparatus of Claim 86, 87, or 89 is disclosed, further comprising a connection timer configured to terminate a wireless connection request when the wireless connection request does not result in a wireless network connection within a specified time.

In Example 91, the apparatus of Claim 86, 87, or 89 is disclosed, wherein the WCRV is a WPS compliant device.

In Example 92, the apparatus of Claim 86, 87, or 89 is disclosed, wherein the WCRV is a Wi-Fi compliant device.

In Example 93, the apparatus of Claim 86, 87, or 89 is disclosed, wherein the WCRV comprises a WPS-button.

In Example 94, the apparatus of Claim 86, 87, or 89 is disclosed, wherein the WCRV comprises a graphical user interface.

In Example 95, the apparatus of Claim 86, 87, or 89 is disclosed, wherein at least two WCRVs are connected to the AP.

In Example 96, the apparatus of Claim 86, 87, or 89 is disclosed, wherein the WCRV eliminates a need for an end user to physically the AP to establish a wireless connection.

In Example 97, the apparatus of Claim 86, 87, or 89 is disclosed, wherein multiple WCRVs can be simultaneously connected to a single AP.

In Example 98, the apparatus of Claim 86, 87, or 89 is disclosed, wherein the WCRV has a display.

In Example 99, the apparatus of Claim 98 is disclosed, wherein the display shows alpha-numeric characters.

In Example 100, the apparatus of Claim 98 or 99 is disclosed, wherein the display is a touchscreen.

In Example 101, the apparatus of Claim 98 or 99 is disclosed, wherein the display is a television screen.

In Example 102, the apparatus of Claim 98 or 99 is disclosed, wherein the display is a computer monitor.

In Example 103, the apparatus of Claim 98 or 99 is disclosed, wherein the display is an LCD screen.

In Example 104, the apparatus of Claim 86, 87, or 89 is disclosed, wherein the WCRV has a button to acknowledge a connection request.

In Example 105, the apparatus of Claim 86, 87, or 89 is disclosed, wherein the WCRV has a button to support the WPS-button.

In Example 106, the apparatus of Claim 86, 87, or 89 is disclosed, wherein the WCRV has 10 numerical buttons to support a WPS-PIN method of connection to the AP.

In Example 107, the apparatus of Claim 86, 87, or 89 is disclosed, wherein the WCRV has NFC capability to support a WPS-NFC connection to the AP.

In Example 108, a means to establish a wireless network connection is disclosed, comprising a computational circuit to receive a passcode from a Network Access Point, display the passcode, and acknowledge a physical contact with a user.

In Example 109, a non-transient computer readable medium is disclosed, said medium containing program instructions for causing a computer to perform the method of:
establishing a Wi-Fi Protected Setup connection between a network access point and a Wi-Fi Connection Request Verifier;
initiating a wireless connection request between a mobile station and the network access point;
generating a passcode in response to the wireless connection request;
displaying the passcode on the Wi-Fi Connection Request Verifier;
entering the passcode into the mobile station; and
establishing a physical contact between an end user and the Wi-Fi Connection Request Verifier.

In Example 110, the means of Example 108 is disclosed, further comprising the physical contact being established by one of pressing a physical button, pressing a digital button, making a finger print, making a handprint, speaking into a microphone, taking a picture, or activating a slider.

In Example 111, a means to establish a wireless network connection is disclosed, comprising a computational circuit to receive a passcode from a Network Access Point, to display the passcode, and to acknowledge a physical contact with a user.

In Example 111, a Machine-readable storage is disclosed, including machine-readable instructions, when executed, to implement a method or realize an apparatus as claimed in any preceding example.

1. A method adapted to establish a remote connection, comprising:
establishing a Wi-Fi Protected Setup (“WPS”) connection between a network access point (“AP”) and a Wi-Fi Connection Request Verifier (“WCRV”);
initiating an establishment of a wireless connection between a mobile station and the network AP;
generating a passcode for a wireless connection between a mobile station and the network AP;
entering the passcode into the mobile station; and
establishing a physical contact between an end user and the WCRV.

2. The method of claim 1, further comprising displaying the passcode on the WCRV.

3. The method of claim 2, wherein the passcode is a hexadecimal code.

4. The method of claim 3, wherein the passcode is 4 digits long.

5. The method of claim 1, further comprising the network AP transmitting an acceptance of the wireless connection request.

6. The method of claim 1, further comprising the network AP transmitting an encryption information to the mobile station.

7. The method of claim 6, further comprising the Mobile Station and the Network AP employing the encryption information to establish a secure connection between the Network AP and the mobile station.

8. The method of claim 1, further comprising the Network AP being connected to at least two Wi-Fi Connection Request Verifiers.

9. The method of claim 8, wherein the passcode is displayed on the at least two Wi-Fi Connection Request Verifiers.

10. The method of claim 9, wherein the physical contact between the end user and the WCRV comprises an end user engaging an input component on the WCRV.

11. The method of claim 10, wherein the input control is a physical push-button on the WCRV, and the physical push-button must be pressed to establish a network connection.

12. The method of claim 10, wherein the input control is a digital button on the WCRV, and the digital button must be engaged to establish a network connection.

13. The method of claim 1, further comprising the Network AP receiving a wireless connection request from the Mobile Station, and the Network AP creating a unique request ID in response.

14. The method of claim 1, wherein the wireless connection between the Network AP and a mobile station is secured with Wi-Fi Protected Access or Wi-Fi Protected Access II.

15. The method of claim 1, further comprising establishing the wireless connection between the Network AP and the WCRV by entering a Wi-Fi Protected Service PIN into the WCRV.

16. The method of claim 1, further comprising the wireless connection between the Network AP and the Mobile Station being established by bringing the WCRV into close physical proximity to the Network AP and engaging a Wi-Fi Protected Connection Near Field Communication circuit.

17. The method of claim 1, wherein the connection between the Mobile Station and the Network AP is established by engaging a WPS-Button.

18. The method of claim 1, wherein the Network AP denies a request for a connection between a mobile station and the Network AP at the expiration of the predetermined period of time.

19. An apparatus adapted to establish a wireless network connection via remote Wi-Fi Protected Setup, the apparatus comprising:
a Wi-Fi modem configured to transmit and/or receive data between a Network Access Point and a Mobile Station;
an input component configured to report a message to the Network Access Point when engaged; and
a logic circuit configured to:
establish a Wi-Fi Protected Setup connection with a Network Access Point;
receive a passcode from the Network Access Point;
and report an acknowledgement to the Network Access Point upon the input component being engaged.

20. The apparatus of claim 19, further comprising a connection timer configured to terminate a wireless connection request when the wireless connection request does not result in a wireless network connection within a specified time.

21. The apparatus of claim 19, further comprising the WCRV having a display.

22. The apparatus of claim 19, further comprising the WCRV having an input component to acknowledge a connection request.

23. The apparatus of claim 22, wherein the input component is a physical button.

24. The apparatus of claim 22, wherein the input component is a digital button.

25. The apparatus of claim 19, further comprising the Wi-Fi Connection Request Verifier being housed within an automated queueing system.
